(19) United States
(12) Patent Application Publication
(10) Pub. No.: US 2009/0271259 A1
(43) Pub. Date: Oct. 29, 2009

(54) METHOD AND SYSTEM FOR DIRECTED PERSONALIZED MARKETING

(76) Inventor: Blair Fish, East Greenwich, RI (US)

Correspondence Address: BARLOW, JOSEPHS & HOLMES, LTD., 101 DYER STREET, 5TH FLOOR, PROVIDENCE, RI, 02903, US

(21) Appl. No.: 12/110,720

(22) Filed: Apr. 28, 2008

(51) Int. Cl. G06Q 30/00

(52) U.S. Cl. 705/14

(57) ABSTRACT

An improved method and system for conducting a directed marketing/advertising campaign is provided that combines personalized mailings and individualized URL addresses in an integrated manner in order to increase customer response rates and improve the ability of the advertiser to obtain relevant feedback and product information from the potential customer. The method and system generally includes the steps of preparing a personalized targeted mailing, establishing a personalized URL address corresponding to each of the mailers within the targeted mailing, sending the mailing to a plurality of customers wherein the mailer directs the customer to the personalized URL address in order to obtain interactive marketing information, obtaining additional information from the customer regarding their particular needs and interests, presenting the customer with an incentive related to their needs and interests and collecting the additional information related to the customer's needs and interests.

### BACKGROUND OF THE INVENTION

The present invention relates generally to a method and system for conducting a directed marketing/advertising campaign. More specifically, the present invention relates to a method and system for conducting a directed marketing/advertising campaign that combines personalized mailings and individualized Uniform Resource Locator (URL) addresses in a manner that increases customer response rates and improves the ability of the advertiser to obtain relevant feedback and product information from the potential customer.

It is well known that prospective customers in the marketplace today are bombarded with countless advertisements on a daily basis. These advertisements are delivered through every media channel imaginable including television, radio, print media, billboards, email, internet, etc. In the face of this constant bombardment, it is often difficult to get and retain the attention of the customer, thereby reducing the effectiveness of the advertiser's expended advertising dollars. Still further, not only does the advertiser need to get the attention of the customer, they need to hold that attention long enough to get that customer to make the actual purchase. As a result, advertisers are constantly searching for more efficient and effective means to advertise their products and/or services to customers who have a need for their products and/or services, or who are currently spending money on similar products and/or services with a competitor.

In their search for prospective customers, advertisers have developed, in additional to traditionally known advertising channels, numerous direct mail advertising methods in the form of both paper mailings and online electronic advertising. While many of these methods can be quite refined and sophisticated, they all suffer from the drawback that such direct mail models typically employ a shotgun approach. In using a shotgun approach, an advertiser just blindly reaches out to potential customers en masse, hoping that their message sticks in the head of even a few customers. Often advertisers resort to this approach as a result of the fact that marketing and sales channels are not tightly integrated. This is because marketing is typically focused on having a greater breadth of relationships (i.e. the total number of potential customers that can be reached). As a result, they are not properly equipped to leverage existing relationships or to employ knowledge regarding a customer's particular set of needs that is already possessed by their sales force. The lack of integration becomes apparent as the advertiser blindly reaches out to customers lacking any information with regard to the particular interests or needs of those customers. From the customer's point of view, this results a communication that does not resonate with their needs or interests and, therefore, is considered spam and treated junk email that is ignored by the customer or that is sent directly to a customer's junk email folder.

Since a large number of customers react poorly to the shotgun approach, advertisers are making attempts to refine their intended audience by using a targeted approach. Accordingly, in an attempt to overcome the lack of personalization and improve customer response, most advertisers are aware that the Internet contains a wealth of possible contacts and information that can be mined for the purpose of cursory personalization of an advertising message. However, this only provides a marginal improvement in the shotgun approach advertising method in that it is still highly mechanical and suffers from the same principal problem of mistargeted advertising messages. Additionally, it does not provide a means for identifying and gathering data on behavior for specifically identified users or user groups. Further, while personalization gives an advertiser some ability to target individuals and send them correspondence, the advertiser still lacks the ability to receive feedback on whether the individual was even interested in that type of correspondence. Also, the marketer cannot determine if the advertisement was opened, read, or acted upon unless the individual responds in some fashion.

To further add to the difficulty of these targeted advertising campaigns, most current options for electronic web based advertising are very costly and yield limited results. In order to reach an acceptable number of consumers the advertisers must run large campaigns. While these campaigns reach masses of people, they often yield only a single digit return in consumer interest and purchases. For example, only 3-5 consumers in a 100 who see an advertiser's campaign may actually be ready, willing and able to complete an actual purchase. As a result, current consumer advertising methods remain very costly and yield a minimal return for the amount of investment.

Accordingly, there is a need for a method and system of conducting a directed marketing/advertising campaign that yields higher customer response and provides the advertiser the ability to collect data regarding the potential customer. Further there is a need for a method and system for conducting a directed marketing/advertising campaign that combines personalized mailings and individualized Uniform Resource Locator (URL) addresses in a manner that increases customer response rates and improves the ability of the advertiser to obtain relevant feedback and product information from the potential customer. Still further there is a need for method and system of conducting a directed marketing/advertising campaign that yields higher and more reliable customer response thereby maximizing the advertiser's return on their invested advertising dollar.

### BRIEF SUMMARY OF THE INVENTION

In this regard, the present invention provides a method and system for conducting a directed marketing/advertising campaign. As such, the general purpose of the present invention, which will be described subsequently in greater detail, is to provide that a method and system of targeted advertising that combines personalized mailings and individualized Uniform Resource Locator (URL) addresses in an integrated manner that increases customer response rates and improves the ability of the advertiser to obtain relevant feedback and product information from the potential customer.

The method and system of the present invention generally includes the steps of preparing a personalized targeted mailing, establishing a personalized URL address corresponding to each of the mailers within the targeted mailing, sending the mailing to a plurality of customers wherein the mailer directs the customer to the personalized URL address in order to obtain interactive marketing information, obtaining additional information from the customer regarding their particular needs and interests, presenting the customer with an incentive related to their needs and interests and collecting the additional information related to the customer's needs and interests. In the context of the method and system of the present invention, a highly tailored advertising message is presented directly to a targeted group of customers that is both interactive and engaging such that the response and return rate produced by the present invention is dramatically higher than the prior art systems noted above. Since the customer is receiving a message that is tailored to them in particular, the likelihood that such a customer will respond to the advertising by at least visiting the personalized URL address is greatly increased. In turn, even if the customer visits the personalized URL address and does not complete a purchase, additional information regarding that customer has been obtained thereby producing a value, in the form of relevant and reliable data, for the advertiser relative to that expenditure of advertising dollars.

The present invention provides an advertiser of a product and/or service with a method and system that utilizes both the currently available customer data and additional customer data gathering techniques to allow the advertiser to more efficiently focus their marketing efforts towards those customers that are likely to at least consider buying their goods and/or services. This method and system allows businesses to focus their advertising efforts not only on breadth or overall reach but also on relevancy.

It is therefore an object of the present invention to provide a method and system of conducting a directed marketing/advertising campaign that yields higher customer response and provides the advertiser the ability to collect data regarding the potential customer thereby allowing the advertiser to determine who is reading the marketing materials, when the marketing material is being read and what kinds of services are of interest. It is a further object of the present invention to provide a method and system for conducting a directed marketing/advertising campaign that combines personalized mailings and individualized Uniform Resource Locator (URL) addresses in a manner that increases customer response rates and improves the ability of the advertiser to obtain relevant feedback and product information from the potential customer. It is still a further object of the present invention to provide a method and system of conducting a directed marketing/advertising campaign that yields higher and more reliable customer response thereby maximizing the advertiser's return on their invested advertising dollar by achieving better returns on the prospective customer's information assets

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic flow chart depicting the method and system of the present invention.

### DETAILED DESCRIPTION OF THE INVENTION

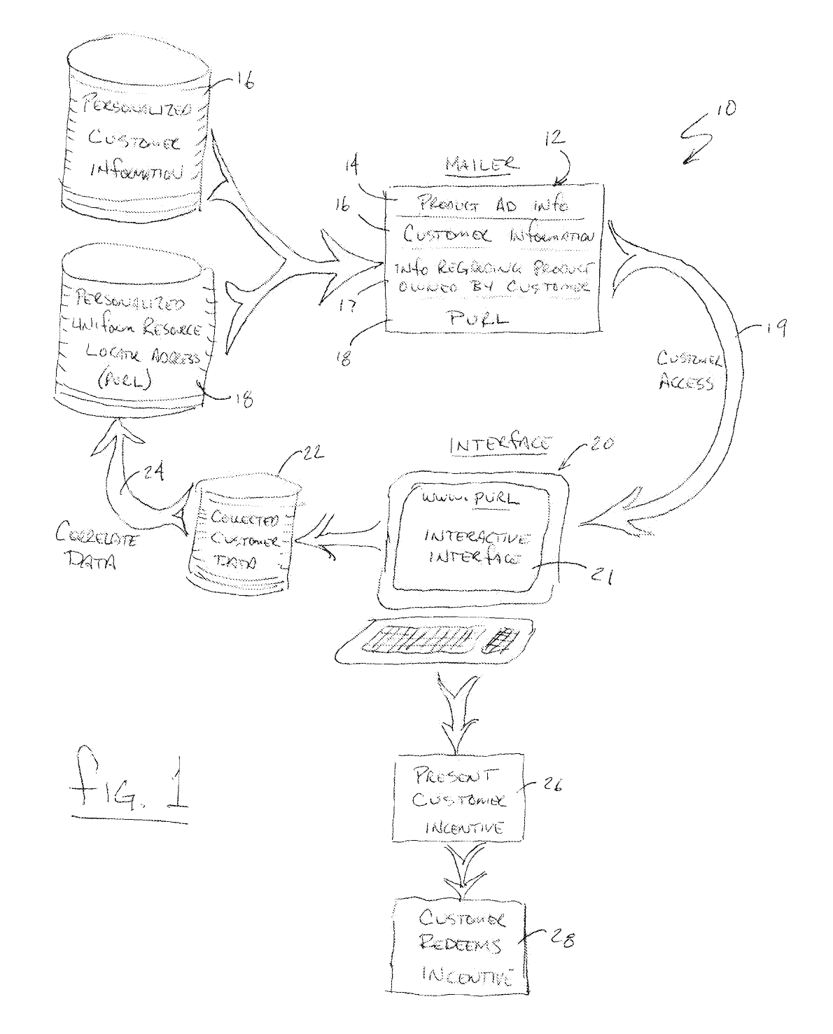

Now referring to the drawings, FIG. 1 has been provided as a generalized depiction of the structure of the method and system of the present invention. FIG. 1 schematically depicts all of the elements and contemplated variations of the current invention and it should be appreciated that the novelty of the invention resides in a portion or a subset of the complete array of elements as depicted in FIG. 1. Accordingly, as was stated above, the present invention is generally directed to a method and system 10 for conducting a directed marketing/advertising campaign that in its most general form includes: preparing a plurality of personalized targeted mailers 12 containing advertisement for a product 14 and personalization information 16 relating each of a plurality of customers, establishing a corresponding plurality of personalized uniform resource locator addresses 18 for each of the mailers 12, sending the mailers 12 to the plurality of customers wherein the mailer 12 directs each of the customers to access their personalized uniform resource locator address 18 via a global communication network, providing the customer with an interactive interface 20 system to enter information regarding their specific needs and interests, obtaining additional information 22 from each of the customers that access the interface 20 using the personalized uniform resource locator addresses 18 and correlating 24 the collected information 22 with the identity of the customer 16.

Turning now to each of the components of the method and system 10 of the present invention in more detail, the basis for the system begins with a listing of potential customers 16 that contains, at a minimum a name and mailing address. The system 10 further relies on at least some additional knowledge regarding those potential customers such as information regarding a product that they currently own 17. Based on the customer listing 16 that contains a plurality of customers, a personalized uniform resource locator (PURL) address 18 is reserved for each discrete customer in the customer information list 16. Once the list 16 is compiled and the PURL addresses 18 are reserved, a targeted direct mailer 12 is prepared. Preferably, the direct mailer 12 contains an advertisement 14 regarding an advertiser's product, the personal information regarding the customer 16, information regarding the product currently owned by the customer 17, a listing of the reserved PURL address 18 corresponding to that customer and instructions directing the customer to access the PURL address 18 via a global communications network 19, such as the Internet, to obtain more information. Those direct mailers 12 are then sent to each of the customers on the potential customer list 16.

It should be appreciated that the personalized mailer 12 is intended to carry information regarding a product currently owned by the customer 17. This allows an advertiser the opportunity to integrate knowledge that the advertiser already knows about the consumer into the advertising material thereby increasing the likelihood that the customer will connect with the advertising. For example, the direct mailer 12 may contain information regarding the car the customer already owns and indicate that the dealer is looking for trade-ins of such cars. The mailer 12 would then instruct the customer to access the PURL address 18 in order to obtain more information about the trade-in value of their car. Further, the mailer 12 may contain information that informs the customer that should they trade in their car, they would get special consideration towards the purchase of a replacement car. Additionally, while the example of a car is provided above, this particular method and system is applicable to any type of good or service available for sale and one skilled in the art should appreciate that the inventive concept lies in the general method and system described herein and is not limited to specific implementations thereof. By way of example, the present invention may be applied to products such as automobiles, boats, real estate, financial planning services, insurance, banking services, home improvement services and home repair services to name a few. By listing the examples above, the Applicant is simply providing examples for illustration purposes and the list is not intended to be comprehensive as many other possible implementations also exist that are not listed herein.

One of the benefits of the present invention is that it not only allows an advertiser to better tailor their advertising message to a consumer, it allows an interactive exchange to occur between the advertiser and the customer. Such an interactive exchange takes place at the interface 20 provided in connection with the PURL address 18. Such an exchange allows both the customer and the advertiser to derive a value. The customer gets value because they are able to obtain additional information regarding the product by visiting the PURL address 18 and will also be presented with a customized incentive 28 that is prepared specifically for them related to their individual needs and interests. In addition, the advertiser gains value because when the customer visits the PURL address 18, the advertiser knows the identity of that person. By knowing the identity of the customer, the advertiser can collect any information that the person enters into the site and can enter it into their records in correlation with the customer's identity. Again using the example of a car, the customer may visit the PURL address 18 and enter the current mileage and condition of their car and may provide any additional options installed on the car in order to obtain a correct trade-in value. All of this information that was previously unknown to the advertiser is now known. Further, in contrast to other sites where the identity of the site visitor is unknown, such as is the case at Kelley Blue Book®, the information that is obtained is connected with a known identity. This gives the advertiser an advantage in that future follow-up advertisements can be better refined and even more targeted.

In interacting with the system 10 of the present invention, the customer visits the interface 20 via a global communication network 19, such as the Internet, by any means already known in the art. Since such accessibility technology is already well known in the art, it will not be discussed further herein. The customer accesses the interface 20 by entering the PURL address 18 and in turn reaches an interface page 21 that is tailor made for them. The interface 20 is interactive and provides space for the customer to input information related to their particular needs and interests. For example, the interface page 21 may include a car trade-in value calculator, a real estate property value calculator, a loan calculator or a retirement needs calculator. After the customer inputs the information, two things happen. First, the data is collected 22 for later use as will be described below. Second, the customer is presented with an incentive offer 26. The incentive offer 26 may be for a discount on an auto purchase, wherein the customer will get an additional $1,000 credit towards their trade-in value or credit towards payment of a discount point on a mortgage rate. Again, while specific examples are provided herein they are meant only to be illustrative and are not meant to be limiting on the scope of the inventive disclosure.

Once presented with the incentive offer 26, the customer can print the offer into a tangible form. In this regard, the interactive system will pre-populate the incentive offer with all of the known information and the newly obtained information so that the incentive offer 26 is complete. The customer is then instructed to take the incentive 26 to the retailer location for redemption 28 towards the advertised products and/or services.

As stated above, the information that the customer enters into the interactive interface 20 is collected in association with the known customer identity. This information is maintained in a reporting system and saved for future use. In this regard, a report can be prepared that contains both the personalization information 16 and the additionally obtained information 22. Further, the collected information 22 can be entered back into the original database of personalized customer information 16 wherein the additionally obtained information 22 is correlated 24 with the personalization information 16 from each of the customers. This portion of the process provides value to the advertisers in that they are able to build an enhanced database with a great deal of higher quality information. This allows future targeted follow-up with customers that is more highly refined. Empirically, the method and system 10 of the present invention had been demonstrated to login rates that approach 75% thereby generating a dramatic return on invested advertising dollar for the advertising client.

In terms of a system 10 for the implementation of the present invention, a system 10 is provided for conducting a targeted advertising campaign that includes a plurality of personalized uniform resource locator addresses 18 for each of a plurality of customers 16, a plurality of personalized targeted mailers 12 containing advertisement for a product 14, personalization information relating each of the customers 16 and information regarding the personalized uniform resource locator address 18 related to each of the customers 16, the mailers 12 being sent to the plurality of customers 16, directing each of the customers to access their personalized uniform resource locator address 18 and an interactive interface 20 that is accessible via a global communication network 19 that allows each of the plurality of the customers to gain access using their personalized uniform resource address 18, wherein the customers utilize the interactive interface 20 in order to enter information regarding their specific needs and interests, the system obtaining additional information from each of the customers 22 and correlating 24 the collected information 22 with the identity of the customer. During implementation, the personalized uniform resource locator addresses 18 are reserved through traditional means for accomplishing such reservations. The customized mailers 12 are then prepared and printed to include all of the above-designated information and those mailers 12 are sent to the customers.

Customer interaction is done through any known type of access device that allows a user to gain access to and view hosted pages having uniform resource locator addresses 18. The interface 20 itself is maintained on any device suitable for the hosting of such an interactive interface including a device such as a computer processor or global communication network server. The customer then interacts with the interface 20 by entering data via their network access device. This allows the customer to obtain a personalized incentive 26 for the purchase of the advertised product as well as allowing the advertiser to obtain customized information related to the customer 22.

It can therefore be seen that the present invention provides a method and system 10 for conducting a directed marketing/advertising campaign that combines personalized mailings 12 and individualized Uniform Resource Locator (URL) addresses 18 in an integrated manner that increases customer response rates and improves the ability of the advertiser to obtain relevant feedback and product information from the potential customer. Further, the method and system 10 of the present invention can be modified for use with virtually any type of goods or services that are offered for sale. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of advertising comprising:
preparing a plurality of personalized targeted mailers containing advertisement for a product and personalization information relating each of a plurality of customers;
establishing a corresponding plurality of personalized uniform resource locator addresses for each of the mailers;
sending the mailers to the plurality of customers wherein the mailer directs each of the customers to access their personalized uniform resource locator address via a global communication network;
providing the customer with an interactive system to enter information and obtain a value regarding their specific needs and interests; and
obtaining additional information from each of the customers that access the personalized uniform resource locator addresses and correlating the collected information with the identity of the customer.

2. The method of claim 1, further comprising:
preparing a customized incentive for the customer related to their individual needs and interests.

3. The method of claim 2, further comprising:
instructing the customer to print the customized incentive for presentation and redemption when purchasing the advertised product.

4. The method of claim 1, wherein the interactive system is a calculator for calculating the current value of a product currently owned by the customer.

5. The method of claim 1, wherein the personalized targeted mailer contains personal information regarding the customer, information regarding a product currently owned by the customer and instructions for visiting a personalized uniform resource locator address wherein the customer can obtain additional information regarding the present value of the currently owned product and information related to a replacement product.

6. The method of claim 5, wherein the interactive system is a calculator for calculating the current value of the product currently owned by the customer.

7. The method of claim 1, further comprising:
preparing a report containing both the personalization information and the additionally obtained information, wherein the additionally obtained information is correlated with the personalization information from each of the customers.

8. The method of claim 1, wherein the product is selected from the group consisting of: automobiles, boats, real estate, financial planning services, insurance, banking services, home improvement services and home repair services.

9. A system for conducting a targeted advertising campaign comprising:
a plurality of personalized uniform resource locator addresses for each of a plurality of customers;
a plurality of personalized targeted mailers containing advertisement for a product, personalization information relating each of the customers and information regarding the personalized uniform resource locator address related to each of the customers, the mailers being sent to the plurality of customers, directing each of the customers to access their personalized uniform resource locator address; and
an interactive interface that is accessible via a global communication network that allows each of the plurality of the customers to gain access using their personalized uniform resource address,
wherein the customers utilize the interactive interface in order to enter information and obtain a value regarding their specific needs and interests, the system obtaining additional information from each of the customers and correlating the collected information with the identity of the customer.

10. The system of claim 9, wherein the system prepares a customized incentive for the customer related to their individual needs and interests.

11. The system of claim 10, wherein the customer prints the customized incentive for presentation and redemption when purchasing the advertised product.

12. The system of claim 9, wherein the interactive system is a calculator for calculating the current value of a product currently owned by the customer.

13. The system of claim 9, wherein the personalized targeted mailer contains personal information regarding the customer, information regarding a product currently owned by the customer and instructions for visiting a personalized uniform resource locator address wherein the customer can obtain additional information regarding the present value of the currently owned product and information related to a replacement product.

14. The system of claim 13, wherein the interactive system is a calculator for calculating the current value of the product currently owned by the customer.

15. The system of claim 9, wherein the system prepares a report containing both the personalization information and the additionally obtained information, wherein the additionally obtained information is correlated with the personalization information from each of the customers.

16. The system of claim 9, wherein the product is selected from the group consisting of: automobiles, boats, real estate, financial planning services, insurance, banking services, home improvement services and home repair services.
